(19) United States
(12) Patent Application Publication
(10) Pub. No.: US 2017/0274239 A1
(43) Pub. Date: Sep. 28, 2017

(54) Knotted Flat Elastic Stretch Band Exercise Bar

(71) Applicant: Edward M. Barella, Westminster, CO (US)

(72) Inventor: Edward M. Barella, Westminster, CO (US)

(21) Appl. No.: 15/469,467

(22) Filed: Mar. 24, 2017

Related U.S. Application Data
(60) Provisional application No. 62/312,467, filed on Mar. 24, 2016.

(51) Int. Cl. A63B 21/055; A61H 23/00; A61H 15/00; A63B 21/04; A63B 23/00

(52) U.S. Cl. CPC A63B 21/0552; A63B 21/0428; A63B 23/00; A61H 15/00; A61H 23/00; A63B 2023/006; A61H 2015/0014

(57) ABSTRACT

A bar or tube with two slots on each side configured to accept a flat or round elastic exercise band or cord; wherein said slots may be rounded along the edges so as not to tear or slice at the elastic exercise band or cord. The elastic exercise band or cord may be tied into knots or bulges on either end and such knots may be inserted into the slots of the bar making it ready for use. The bar may also comprise adapters to adjust the size of the slots to different sizes of flat elastic bands or cords. The invention may also comprise a rubber roller which may be made to house a vibrating unit, said housing unit may be turned on by a switch when held to the body.

### CROSS REFERENCE TO RELATED APPLICATIONS

This application claims the benefit of U.S. Provisional Patent Application No. 62/312,467, filed on Mar. 24, 2016, and titled “Probar Stretchband Plus” which is incorporated by reference herein in its entirety for all purposes.

### BACKGROUND OF THE INVENTION

1. Field of the Invention

The present invention is in the technical field of stretch bands for exercise. More particularly, the present invention pertains to the field of stretch bands used with bars for exercise.

2. Description of Related Art

This provisional patent pertains to improvements in the design of existing exercise bars which only address using a round tube such as the ones described in the following patents U.S. Pat. No. 7,578,775; U.S. Pat. No. 4,059,265; U.S. Pat. No. 4,195,835; and other variations of the same which all use round elastic stretch exercise bands. This provisional patent helps the millions of users in their exercise routines, physical therapy and rehab treatments. It is a new concept of combining the flat stretch band and a bar with a very unique design described below.

### SUMMARY

The scope of the present invention is defined solely by the appended claims and detailed description of a preferred embodiment; and is not affected to any degree by the statements within this summary. The present invention describes a bar or tube with two slots on each side. The slots are rounded along the edges so as not to tear or slice at an elastic stretch exercise band, which may be tied into knots on either end and inserted into the slots of the bar. The bar can be a bar with or without adaptors. The invention may also comprise a rubber roller which may be made to house a vibrating unit, said housing unit may be turned on by a switch when held to the body. In another embodiment of the invention the bar may be formed so as to accommodate and size of round or flat elastic stretch exercise band.

### BRIEF DESCRIPTION OF THE DRAWINGS

Various embodiments are described herein with reference to the following Drawings. Certain aspects of the Drawings are depicted in a simplified way for reason of clarity. Not all alternatives and options are shown in the Drawings and, therefore, the Claims are not limited in scope to the content of the Drawings.

### FIGURES

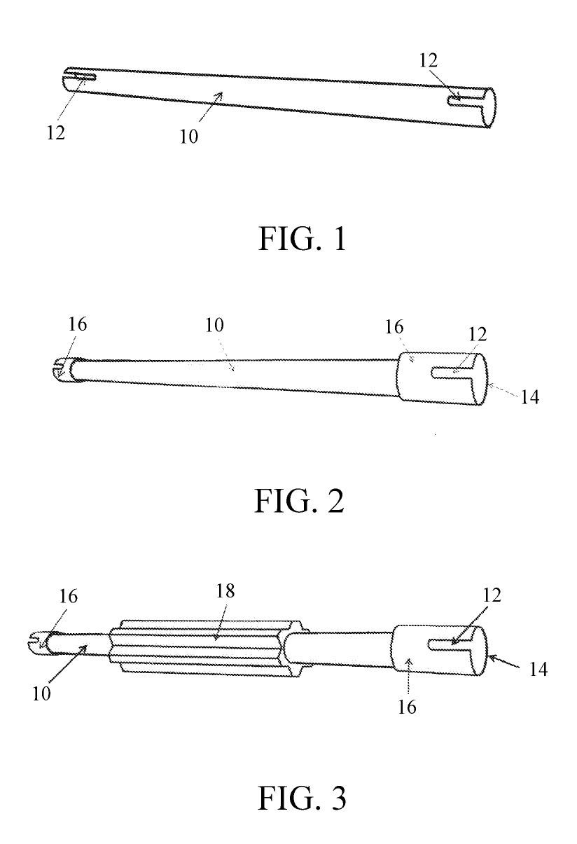

FIG. 1 illustrates a bar with slots on each end, in accordance with an embodiment of the present disclosure.

FIG. 2 illustrates a bar with slots and adapters on each end, in accordance with an embodiment of the present disclosure.

FIG. 3 illustrates a bar with slots on each end, adapters and a massage roller, in accordance with an embodiment of the present disclosure.

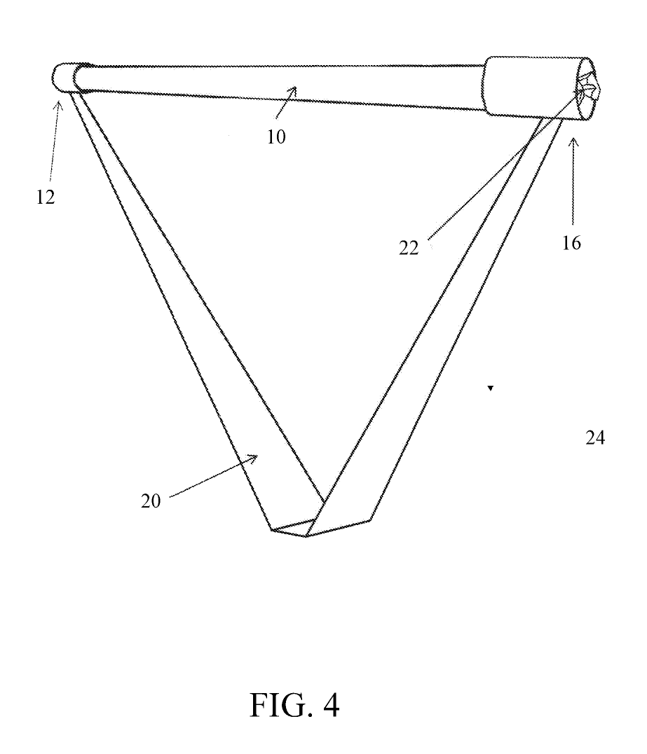

FIG. 4 illustrates a bar with slots on each end, adapters, and a flat elastic exercise band, in accordance with an embodiment of the present disclosure.

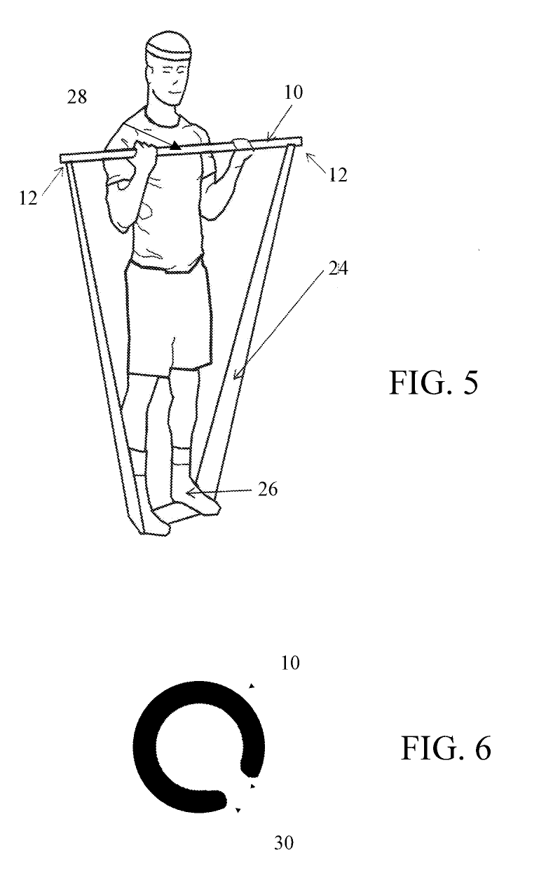

FIG. 5 illustrates a person using a bar with slots on each end, adapters, and a flat elastic exercise band, in accordance with an embodiment of the present disclosure.

FIG. 6 illustrates a cross section of the end of a bar with slots on each end showing the curvature of the opening of the slot, in accordance with an embodiment of the present disclosure.

Corresponding reference characters indicate corresponding components throughout the several figures of the Drawings. Elements in the several figures are illustrated for simplicity and clarity and have not necessarily been drawn to scale. For example, the dimensions of some of the elements in the figures may be emphasized relative to other elements for facilitating understanding of the various presently disclosed embodiments. Also, common, but well-understood elements that are useful or necessary in commercially feasible embodiment are often not depicted in order to facilitate a less obstructed view of these various embodiments of the present disclosure.

### REFERENCES

10 An Exercise Bar Or Tube
12 Slots On Ends Of Tube
14 Hole On End Of Tube
16 Adapter
18 Massage Roller
20 Flat Elastic Stretch Band
22 Knot or Bulge In End Of Elastic Stretch Band
24 Flat Elastic Stretch Band With Knots On The Ends
26 Shoeless Operation
28 Vibrating Unit
30 Rounded Slot Edges

### DETAILED DESCRIPTION

The following description is not to be taken in a limiting sense, but is made merely for the purpose of describing the general principles of exemplary embodiments, many additional embodiments of this invention are possible. It is understood that no limitation of the scope of the invention is thereby intended. The scope of the disclosure should be determined with reference to the Claims. Reference throughout this specification to “one embodiment,” “an embodiment,” or similar language means that a particular feature, structure, or characteristic that is described in connection with the embodiment is included in at least one embodiment of the present disclosure. Thus, appearances of the phrases “in one embodiment,” “in an embodiment,” and similar language throughout this specification may, but do not necessarily, all refer to the same embodiment.

Further, the described features, structures, or characteristics of the present disclosure may be combined in any suitable manner in one or more embodiments. In the Detailed Description, numerous specific details are provided for a thorough understanding of embodiments of the disclosure. One skilled in the relevant art will recognize, however, that the embodiments of the present disclosure can be practiced without one or more of the specific details, or with other methods, components, materials, and so forth. In other instances, well-known structures, materials, or operations are not shown or described in detail to avoid obscuring aspects of the present disclosure. Any alterations and further modifications in the illustrated devices, and such further application of the principles of the invention as illustrated herein are contemplated as would normally occur to one skilled in the art to which the invention relates.

Unless otherwise indicated, the drawings are intended to be read (e.g., arrangement of parts, proportion, degree, etc.) together with the specification, and are to be considered a portion of the entire written description of this invention. As used in the following description, the terms “horizontal”, “vertical”, “left”, “right”, “up” and “down”, as well as adjectival and adverbial derivatives thereof (e.g., “horizontally”, “rightwardly”, “upwardly”, etc.), simply refer to the orientation of the illustrated structure as the particular drawing figure faces the reader. Similarly, the terms “inwardly” and “outwardly” generally refer to the orientation of a surface relative to its axis of elongation, or axis of rotation, as appropriate. Also, as used herein, terms such as “positioned on” or “supported on” mean positioned or supported on but not necessarily in direct contact with the surface.

The phrases “at least one,” “one or more,” and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together. The terms “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

For the purposes of promoting an understanding of the principles of the present invention, reference will now be made to the embodiments illustrated in the drawings and specific language will be used to describe the same.

Figure (FIG.) #1 illustrates an embodiment of an exercise bar or tube (10) with two or more slots (12) cut into each end of the bar extending inward from the holes on the ends of the tube (14). The bar or tube (10) may be made of any material suitable to its purpose and would preferably be made of metal or plastic. The bar (10) may also be an assembly of shorter bars or tubes.

FIG. 2 illustrates another embodiment of an exercise bar (10) with slots (12) and also adapters (16) which removably attach to the ends of the bar and narrow the width of the slots (12) so that they may receive different sizes of flat elastic bands or cords and allow such bands or cord to pass through the slot with various amounts of resistance.

FIG. 3 illustrates another embodiment of an exercise bar (10), with slots (12), adapters (16), and a massage roller (18). The massage roller may be made of any material suitable to its purpose.

FIG. 4 illustrates the use of the exercise bar (10) with an elastic stretch band or cord (24). The elastic stretch band may be round or flat, but is preferably flat (as pictured). The user ties a knot or bulge (22) in either end of the elastic stretch band and slides the knot though the hole (14) in the end of the bar (10) and along the slot (12) so that the slot is narrow enough to prevent the elastic stretch band's knot (22) from going through the slot, thereby holding the bar and elastic stretch band or cord in a state of tension (24) when it is stretched, which also prevents the knot (22) from coming out of the bar (10). The slot (12) may be wide enough to apply enough tension to hold the elastic stretch band or cord (24) in place when the elastic stretch band or cord (24) is not being stretched; the adapters (16) can help achieve this state for various thickness of elastic stretch bands or cords (24).

FIG. 5 illustrates the use of the exercise bar (10) as illustrated in FIG. 4. In this illustration you can clearly see that by using a flat elastic stretch band you are able to exercise without the use of shoes. No current exercise bar incorporates the use of a flat elastic stretch band. In this picture a vibrating unit (28) may be placed on or in the bar (10). The vibrating unit (28) may be activated by moving the bar in any manner, such as that as illustrated in the FIG.

FIG. 6 illustrates a cross section of the end of the bar (10) clearly showing the rounded edges of the slot (30). The rounding of the edges is very important to prevent any tearing or slicing of the elastic exercise band or cord. The attachments (16) capable of narrowing the width of the slot also have rounded edges

Information as herein shown and described in detail is fully capable of attaining the above-described object of the present disclosure, the presently preferred embodiment of the present disclosure; and is, thus, representative of the subject matter; which is broadly contemplated by the present disclosure. The scope of the present disclosure fully encompasses other embodiments which may become obvious to those skilled in the art, and is to be limited, accordingly, by nothing other than the appended claims, wherein any reference to an element being made in the singular is not intended to mean “one and only one” unless explicitly so stated, but rather “one or more.” All structural and functional equivalents to the elements of the above described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for such to be encompassed by the present claims. Furthermore, no element, component, or method step in the present disclosure is intended to be dedicated to the public regardless of whether the element, component, or method step is explicitly recited in the claims. However, that various changes and modifications in form, material, work-piece, and fabrication material detail may be made, without departing from the spirit and scope of the present disclosure, as set forth in the appended claims, as may be apparent to those of ordinary skill in the art, are also encompassed by the present disclosure.

What is claimed is:

1. An exercise bar or tube, comprising:
a bar or tube, wherein said bar or tube comprises two ends with a hole in each;
said ends of said holes have at least one slot that extends from said hole at said end of said bar inward;
wherein said slot in said bar has rounded slot edges.

2. The exercise bar or tube of claim 1, further comprising attachments capable of narrowing the width of the slot.

3. The exercise bar or tube of claim 2, wherein the attachments capable of narrowing the width of the slot also have rounded edges.

4. The exercise bar or tube of claim 1, further comprising massage roller.

5. The exercise bar or tube of claim 1, wherein said bar or tube may be comprised of an assembly of shorter bars or tubes.

6. The exercise bar or tube of claim 1, further comprising an elastic stretch band, wherein said rounded edges of said slots prevent the tearing or slicing of said elastic stretch band.

7. The exercise bar or tube of claim 6, wherein said elastic stretch band is flat.

8. The exercise bar or tube of claim 7, wherein said flat elastic stretch band is tied into a knot or bulge at its ends.

9. The exercise bar or tube of claim 8, wherein said flat elastic stretch band and said knot or bulge are inserted into said holes at the ends of said bars or tubes into said slots.

10. The exercise bar or tube of claim 6, wherein said elastic stretch band is a cord.

11. The exercise bar or tube of claim 10, wherein said elastic stretch cord is tied into a knot or bulge at its ends.

12. The exercise bar or tube of claim 11, wherein said elastic stretch cord and said knot or bulge are inserted into said holes at the ends of said bars or tubes into said slots.
